(19) United States
(12) Patent Application Publication
(10) Pub. No.: US 2026/0167550 A1
(43) Pub. Date: Jun. 18, 2026

(54) Method of Preparation of a Multicore Fiber Preform

(71) Applicant: Heraeus Quartz North America LLC, Buford, GA (US)

(72) Inventors: Jong-Won LEE, Buford, GA (US); Qiulin Ma, Buford, GA (US); Evan P. Green, Buford, GA (US); Nicholas Curren Leblanc, Buford, GA (US)

(21) Appl. No.: 18/984,338

(22) Filed: Dec. 17, 2024

(51) Int. Cl. C03B 37/012; C03B 37/15; G02B 6/02

(52) U.S. Cl. CPC C03B 37/01222; C03B 37/01234; C03B 37/01245; C03B 37/15; G02B 6/02042; C03B 2203/34

(57) ABSTRACT

A method of manufacturing a multicore fiber preform includes providing first and second cylinders each extending longitudinally between opposing first and second ends, forming longitudinally extending first holes in the first cylinder and longitudinally extending second holes in the second cylinder, forming at least one first recess in the first end of the first cylinder such that the first holes each terminate at the first recess at a location axially spaced apart from the first end of the first cylinder; facing the first end of the first cylinder to the second end of the second cylinder and axially aligning each of the first holes with respective second holes, welding the first end of the first cylinder to the second end of the second cylinder, and for each first hole and its respective axially aligned second hole, inserting a respective core rod assembly.

### TECHNICAL FIELD

The present disclosure relates generally to the field of optical fiber technology and, more particularly, to methods of preparing multicore fiber (MCF) preforms from two or more MCF cylinders for high yield multicore fibers.

### BACKGROUND

An optical fiber is a flexible, transparent fiber made by drawing glass (fused silica) down to a diameter that can be as small as slightly thicker than that of a human hair. Optical fibers are used most often to transmit light between the two ends of the fiber and are widely in fiber-optic communications, where they permit transmission over longer distances and at higher bandwidths (data rates) than wire cables. Optical fibers are used instead of metal wires because signals travel along fibers at high capacity with reduced loss. In addition, optical fibers are immune to electromagnetic interference, a problem that plagues metal wires. Optical fibers are also used for illumination and are wrapped in bundles so that they may carry images, thus allowing viewing in confined spaces, as in the case of a fiberscope. Specially designed optical fibers are also used for a variety of other applications, such as fiber optic sensors and fiber lasers.

Optical fibers typically include a transparent core surrounded by a transparent cladding material with a lower index of refraction. Light is kept in the core by the phenomenon of total internal reflection, which causes the optical fiber to act as a waveguide. Optical fibers that support many propagation paths or transverse modes are called multimode fibers; those that support a single mode are called single-mode fibers. An optical fiber is generally produced by heating a prefabricated preform inside a furnace and elongating the preform into the optical fiber. One preform might yield on the order of 7,000 to 8,000 km of optical fiber.

MCF transmission technologies have been widely studied as the simplest form of spacial multiplexing (SM) or space-division multiplexing (SDM) and as an answer to the increasing demand for bandwidth. SDM refers, in fiber optic communication systems, to the use of the transverse dimension of the fiber to separate the channels. MCF technologies contain multiple cores within a single cladding. Each core of the MCF can accommodate a single mode or a number of modes depending on the method of SDM used. Typically, the MCF has two to eight cores, but other numbers of cores are possible.

One common type of MCF preform includes a cylinder that forms the cladding of the preform and has a plurality of holes extending longitudinally therethrough. Each of a plurality of core rods is inserted into a respective one of the holes. The cylinder, with the core rods inserted, is heated by exposing the cylinder and core rods to a heating element of a furnace, thereby integrating the core rods and the cylinder. Longer cylinders allow for an increase in productivity, however, numerous challenges are presented when the cylinder includes multiple holes.

Drilling is the biggest challenge when utilizing a long cylinder, as tolerances become more difficult to control in maintaining straight holes all the way through the cylinder. Since there are more holes, deviations in direction can be amplified as holes may get too close to the edge or to one another. One solution that has been proposed is to combine multiple short cylinders to create a longer overall cylinder. This presents alignment issues, as the cylinders need to be aligned not only longitudinally, but the individual holes of the cylinders must also be aligned correctly to allow complete passage of the core rods into the assembly. Holes close to the outer edge of the cylinders are also more vulnerable to heat, and the holes even near the center could shrink when welding the cylinders together.

U.S. Patent Application Publication No. 2022/0306516 features an embodiment where multiple glass cladding sections are stacked with their axial holes aligned. A core rod assembly (or cane) is added to each axial hole to define a cane-cladding assembly. The opposite ends of the stacked cladding assembly are capped to define a preform assembly with a substantially sealed internal chamber. A vacuum is applied through the top cap to create a pressure differential that keeps the components of the preform assembly together. The vacuum-held preform assembly is heated to just above the glass-softening point to consolidate the vacuum-held preform assembly into a solid glass preform for elongating into an optical fiber, which may be done in the same furnace as that used to consolidate the vacuum-held preform assembly. This process has the disadvantage that extra parts (e.g., top and bottom caps) are required to assemble the preform based on the use of a vacuum to hold the components together. In addition, empty spaces between the glass cladding sections in the stack may cause undesirable glass flow during the collapsing of the assembly and cause a pitch error in the pulled fiber.

Accordingly, there is a need for a method of achieving a long MCF preform for high yield fiber preparation that includes good alignment of multi-hole glass cladding cylinders with a simple design of the glass cladding structure and which is able to maintain the hole structure throughout the formation process.

### SUMMARY

To meet these and other needs, the present disclosure provides a method of manufacturing a multicore fiber preform. The method includes: (a) providing a first cylinder extending longitudinally between opposing first and second ends; (b) providing a second cylinder extending longitudinally between opposing first and second ends; (c) forming a plurality of first holes in the first cylinder that each have a generally constant first inner diameter and extend longitudinally through the first cylinder and forming a plurality of second holes in the second cylinder that each have a generally constant second inner diameter and extend longitudinally through the second cylinder; (d) forming at least one first recess in the first end of the first cylinder such that the plurality of first holes each terminate at the at least one first recess at a location axially spaced apart from the first end of the first cylinder; (e) facing the first end of the first cylinder to the second end of the second cylinder and axially aligning each of the plurality of first holes with respective ones of the plurality of second holes; (f) welding the first end of the first cylinder to the second end of the second cylinder; and (g) for each first hole and its respective axially aligned second hole, inserting a respective core rod assembly.

The at least one first recess may include a plurality of first recesses, with each of the plurality of first recesses being connected to a respective one of the plurality of first holes, and each of the plurality of first recesses forming an opening at the first end of the first cylinder having a diameter that is greater than the first inner diameter. The plurality of first recesses may be formed by removing material from the first cylinder surrounding the first holes at the first end of the first cylinder, in particular by chamfering edges of the first holes at the first end of the first cylinder. The method may further include forming a plurality of second recesses in the second end of the second cylinder, with each of the plurality of second recesses being connected to a respective one of the plurality of second holes such that the plurality of second holes each terminate at respective ones of the second recesses at a location axially spaced apart from the second end of the second cylinder. Each of the plurality of second recesses may form an opening at the second end of the second cylinder having a diameter that is greater than the second inner diameter. The method may also include forming a plurality of intermediate recesses in the second end of the first cylinder, with each of the plurality of intermediate recesses being connected to a respective one of the plurality of first holes such that the plurality of first holes each terminate at respective ones of the intermediate recesses at a location axially spaced apart from the second end of the first cylinder. Each of the plurality of intermediate recesses may form an opening at the second end of the first cylinder having a diameter that is greater than the first inner diameter.

The at least one first recess may include a single first recess having a diameter less than an outer diameter of the first cylinder, with each of the first holes being connected to the single first recess. The method may further include forming a second recess in the second end of the second cylinder, with the second recess having a diameter less than an outer diameter of the second cylinder, such that the plurality of second holes each terminate at the second recess at a location axially spaced apart from the second end of the second cylinder. The method may further include forming an intermediate recess in the second end of the first cylinder, with the intermediate recess having a diameter less than an outer diameter of the first cylinder, such that the plurality of second holes each terminate at the intermediate recess at a location axially spaced apart from the second end of the first cylinder.

The step of axially aligning each of the plurality of first holes with respective ones of the plurality of second holes may include: (i) inserting first prongs of a rotational alignment jig into two or more of the plurality of first holes at the first end of the first cylinder such that second prongs extend away from the first end of the first cylinder, (ii) axially aligning the first cylinder with the second cylinder and rotating the second cylinder until two or more of the plurality of second holes align with the second prongs of the rotational alignment jig, (iii) inserting the second prongs into the two or more of the plurality of second holes, (iv) fixing a rotational position of the first and second cylinders with respect to each other, and (v) removing the alignment jig from the first holes and the second holes. The method may further include during welding, flowing gas through the first and second holes. A length of each core rod assembly may be generally equal to or greater than a combined length of the first cylinder and the second cylinder.

In another aspect, the present disclosure provides a method of manufacturing a multicore optical component. The method may include: (a) providing a multicore fiber preform according to the embodiment described above; and (b) heating the multicore fiber preform in a furnace to collapse the first and second cylinders onto the inserted core rod assemblies and to elongate the multicore fiber preform into one of a second preform or a multicore optical fiber. The elongation step is one of performed simultaneously with the collapsing step or following the collapsing step.

It is understood that embodiments described herein may be used alone or in combinations with each other.

### BRIEF DESCRIPTION OF THE DRAWINGS

The following detailed description of embodiments will be better understood when read in conjunction with the appended drawings. It should be understood, however, that the disclosure is not limited to the precise arrangements and instrumentalities shown. In the drawings:

FIG. 1 is a side elevational cross-sectional view of two MCF cylinders that implement a plurality of recesses corresponding to respective holes in accordance with an example method of forming an MCF preform;

FIG. 2 is a side elevational cross-sectional view of the MCF cylinders of FIG. 1 connected to one another using a rotational alignment jig;

FIG. 3 is a side elevational cross-sectional view of the MCF cylinders of FIG. 1 during a purging and welding process;

FIG. 4 is a side elevational cross-sectional view of the MCF cylinders of FIG. 1 after welding and during insertion of core rod assemblies into respective holes of the cylinders;

FIG. 5 is a side elevational cross-sectional view of an MCF preform formed by the MCF cylinders and inserted core rods of FIG. 4 while the preform is undergoing a collapse and elongation process; and

FIG. 6 is a side elevational cross-sectional view of two MCF cylinders that implement single recesses encompassing respective pluralities of holes in accordance with another example method of forming an MCF preform.

### DETAILED DESCRIPTION

Certain terminology is used in the following description for convenience only and is not limiting. The words “right”, “left”, “lower”, and “upper” designate directions in the drawings to which reference is made. The words “inwardly” and “outwardly” refer to directions toward and away from, respectively, the geometric center of the device and designated parts thereof. The terminology includes the above-listed words, derivatives thereof, and words of similar import. Additionally, the words “a” and “an”, as used in the claims and in the corresponding portions of the specification, mean “at least one.”

It should also be understood that the terms “about,” “approximately,” “generally,” “substantially” and like terms, used herein when referring to a dimension or characteristic of a component, indicate that the described dimension/characteristic is not a strict boundary or parameter and does not exclude minor variations therefrom that are functionally similar. At a minimum, such references that include a numerical parameter would include variations that, using mathematical and industrial principles accepted in the art (e.g., rounding, measurement or other systematic errors, manufacturing tolerances, etc.), would not vary the least significant digit.

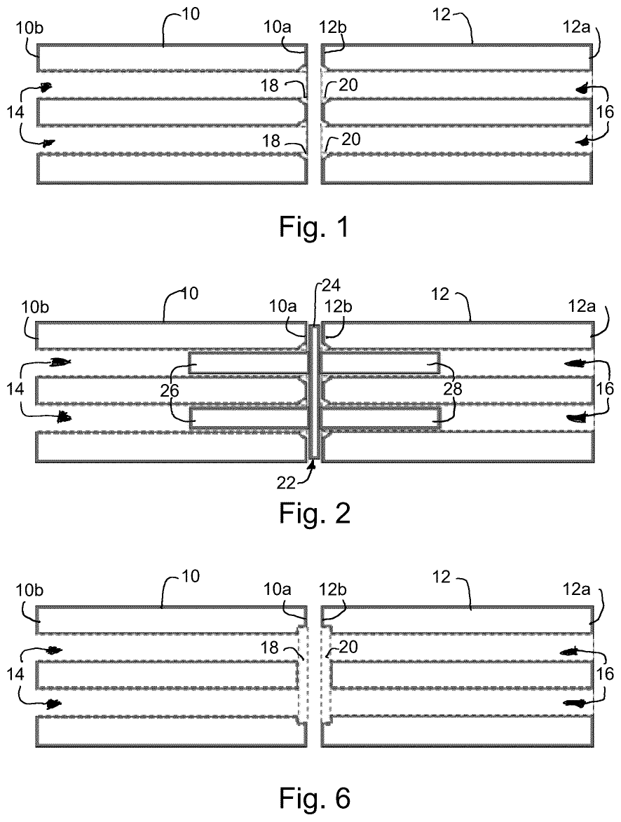

Referring to FIG. 1, an MCF preform may be manufactured by starting with the provision of a plurality of MCF cylinders. In FIG. 1, a first cylinder 10 and a second cylinder 12 are shown, but additional cylinders of like structure may be used depending on a desired final length of the MCF preform. Each of the first and second cylinders 10, 12 is of a cylindrical or tubular configuration and extends longitudinally between respective opposing first ends 10a, 12a, and second ends 10b, 12b. Each of the first and second cylinders 10, 12 may be a cladding made from pure quartz glass or a doped quartz glass. Preferably, however, the cylinders 10, 12 are of the highest purity synthetic silica whether un-doped or doped (e.g., with Fluorine). The cylinders 10, 12 may have a length between about 0.5 m to about 3.5 m, more preferably, about 1.5 m, although other lengths may alternatively be used. While the cylinders 10, 12 shown in the drawings have substantially similar lengths, the cylinders 10, 12 may also have different lengths from each other, depending on design and manufacturing factors or the like. The cylinders 10, 12 may have outer diameters between about 70 mm and about 250 mm, more preferably between about 70 mm and 220 mm, although other outer diameters outside of these ranges may alternatively be used. Again, the cylinders 10, 12 shown in the drawings have substantially similar outer diameters, but there may be circumstances where the outer diameters do not match, depending on design and manufacturing factors or the like.

A plurality of first holes 14 may be formed in the first cylinder 10. Each of the first holes 14 may extend longitudinally through the first cylinder 10 and have a generally constant inner diameter. The inner diameter of each first hole 14 may be between about 10 mm and about 43 mm, more preferably between about 20 mm and about 43 mm, although larger or smaller inner diameters may be used, which will depend on the outer diameter of the cylinder 10, manufacturing capabilities, other design or manufacturing factors, or the like. The first holes 14 may be formed by a drilling process, as is conventionally known. In circumstances where very small inner diameter first holes 14 are required (e.g., about 20 mm or below), the hole size can be reduced by, for example, stretching a drilled cylinder. Although two first holes 14 are shown in FIG. 1 as being symmetrically placed about an axial center of the first cylinder 10, the number of first holes 14 and the relative spatial arrangement thereof (e.g., with respect to the axial center of the first cylinder 10, pitch(es) between neighboring first holes 14, and the like) may vary depending on the intended design of the resulting optical fiber. For example, first holes 14 may be arranged asymmetrically with respect to the axial center of the first cylinder 10, different numbers of first holes 14 may be provided, or the like. Moreover, while the inner diameters of the first holes 14 are shown in FIG. 1 as being generally equal, inner diameters of the first holes 14 may vary with respect to one another according to design requirements.

A second plurality of holes 16 may be formed in the second cylinder 12 in a manner similar to that described above with respect to the first holes 14. The inner diameters, pitches, and locations of the second holes 16 are intended to match corresponding ones of the first holes 14 as the first and second holes 14, 16 will ultimately be aligned when the first and second cylinders 10, 12 are combined into an MCF preform. The process to form holes may also be performed for any additional cylinders (not shown) that are to be assembled together with the first and second cylinders 10, 12 into the MCF preform.

To assemble the preform, the first end 10a of the first cylinder 10 may be welded to the second end 12b of the second cylinder 12. To prevent the aforementioned narrowing or closing of the holes 14, 16 at the interface of the first and second cylinders 10, 12, at least one first recess 18 may be formed in the first end 10a of the first cylinder 10 such that the plurality of first holes 14 each terminate at the at least one first recess 18 at a location axially spaced apart from the first end 10a of the first cylinder 10. The at least one first recess 18 may be formed before or after the first holes 14 are formed, or in some embodiments, generally simultaneously therewith.

In the example shown in FIG. 1, a plurality of first recesses 18 are formed in the first end 10a of the first cylinder 10, each of which is connected to a respective one of the first holes 14. In this manner, each of the first recesses 18 forms an opening at the first end 10a of the first cylinder 10 that has a diameter greater than the inner diameter of the respective first hole 14. For example, the first recesses 18 may be formed by removing material from the first cylinder 10 surrounding the first holes 14 at the first end 10a of the first cylinder 10. This process can be done by, for example, drilling at the first end 10a of the first cylinder 10 with a larger diameter bit than one used to drill the first holes 14 or otherwise using a bit having a larger diameter than that of the first holes 14 being processed. In the particular example shown in FIG. 1, edges of the first holes 14 are chamfered at the first end 10a of the first cylinder 10 to create recesses 18 that have a larger diameter at the first end 10a of the first cylinder 10 that then taper toward the respective openings of the first holes 14, which are now axially spaced from the first end 10a by the respective recesses 18. Although the recess 18 walls in FIG. 1 are shown as appearing frustoconical in shape between the opening at the first end 10a and the inner diameter of the first holes 14, other shapes may be formed as well, including spherical, parabolic, polygonal, combinations thereof, or the like. In still other embodiments, the recesses 18 may be cylindrical in shape, with a generally constant recess inner diameter that then steps to the inner diameter of the first holes 14. The recesses 18 may have a depth that is greater than or equal to about 5 mm, although smaller depths may be utilized depending on design factors or the like. The recesses at the first end 10a of the first cylinder 10 help to prevent bulging or other deformation of material that could narrow or block the first and/or second holes 14, 16 when welding the first and second cylinders 10, 12 to one another.

It should be noted that the order in which the first holes 14 and the first recesses 18 are formed is not critical. In particular, the first holes 14 may be formed prior to formation of the first recesses 18, the first recesses 18 may be formed prior to formation of the first holes 14, individual first hole 14 and first recess 18 pairs may be formed (in either order) sequentially, or the like.

In some embodiments, it can be sufficient to form recesses only in the first end 10a of the first cylinder 10. However, in other embodiments, it can be beneficial to form matching second recesses 20 in the second end 12b of the second cylinder 12. For example, a plurality of second recesses 20 may be formed, each of which is connected to a respective one of the second holes 16. In this manner, each of the second recesses 20 forms an opening at the second end 12b of the second cylinder 12 that has a diameter greater than the inner diameter of the respective second hole 16. As with the first recesses 18, the second recesses 20 may be formed by removal of material, such as by chamfering or other like processes. The formation of recesses 18, 20 at both the first end 10a of the first cylinder 10 and the second end 12b of the second cylinder 12, as shown in FIG. 1, can further improve the prevention of obstructions or blocking of the first and second holes 14, 16 when the first and second cylinders 10, 12 are welded together. As with the first holes 14 and first recesses 18, formation of the second holes 16 and the second recesses 20 can take place in any desired order.

In embodiments where more than two cylinders are used to make the preform, it may be advisable to form recesses on both ends of a cylinder. For example, a plurality of intermediate recesses (not shown) may be formed in the second end 10b of the first cylinder 10, each of which is connected to a respective one of the first holes 14. In this manner, each of the intermediate recesses forms an opening at the second end 10b of the first cylinder 10 that has a diameter greater than the inner diameter of the respective first hole 14. As with the first and second recesses 18, 20, the intermediate recesses may be formed by removal of material, such as by chamfering or other like processes. Similar intermediate recesses may be made in the first end 12a of the second cylinder 12, if needed. As with the first and second recesses 18, 20, intermediate recesses may be made in any desired order relative to the hole(s) to which they apply.

FIG. 6 shows an alternative embodiment wherein, instead of having individual first recesses 18 associated with each of the first holes 14 in the first cylinder 10, a single first recess 18 may be formed in the first end 10a of the first cylinder 10. The single first recess 18 may have a diameter that is less than an outer diameter of the first cylinder 10, while each of the first holes 14 in the first cylinder 10 are connected to the single first recess 18. The single first recess 18 may have a depth greater than or equal to about 5 mm, although smaller depths may be used as well, depending on design factors or the like. The single first recess 18 also preferably has a diameter that is large enough to encompass the desired number of first holes 14. The first recess 18 may be formed using, for example, a drill bit of appropriate diameter. In the embodiment shown in FIG. 6, the first recess 18 is cylindrical in shape, but edges of the recess 18 may also be chamfered, curved, sloped, combinations thereof, or the like. The configuration shown in FIG. 6 is particularly useful when spacing between the first holes 14 is too small) to allow for chamfering or other material removal operations to create individual recesses 18 for each of the first holes 14. For example, chamfering may need to be about 5 mm wide, so where the spacing is less than about 10 mm, the configuration shown in FIG. 6 may be advantageous. However, depending on design factors and hole and cylinder diameters, spacing greater than about 10 mm may also benefit from the use of the configuration shown in FIG. 6. The larger first recess 18 encompassing all of the first holes 14 can provide similar benefits to the FIG. 1 embodiment, i.e., when welding the first end 10a of the first cylinder 10 to the second end 12b of the second cylinder 12, the likelihood of bulging or other obstruction of the first and/or second holes 14, 16 is significantly reduced.

Similar to the embodiment described above, the order of forming the first holes 14 and the first recess 18 is not critical. In particular, the first holes 14 may be formed prior to formation of the first recess 18, the first recess 18 may be formed prior to formation of the first holes 14, or the like. When the first recess 18 is formed prior to the first holes 14, even smaller spacing between first holes 14 (e.g., around 3 mm) can be achieved.

Although in FIG. 6 the recess 18 is shown as a single recess 18 encompassing all of the first holes 14, combinations of the embodiments from FIGS. 1 and 6 can be utilized as well. That is, there may be recesses 18 that encompass multiple first holes 14, while other first holes 14 have their own separate recesses 18. Such configurations may be useful where some of the first holes 14 have narrower spacing with respect to one another than others.

As seen in FIG. 6, the second cylinder 12 may be similarly arranged so as to have a single second recess 20 in the second end 12b thereof. The single second recess 20 may have a diameter that is less than an outer diameter of the second cylinder 12, while each of the second holes 16 in the second cylinder 12 are connected to the single second recess 20. In this configuration, when the first end 10a of the first cylinder 10 is brought together with the second end 12b of the second cylinder 12 for welding, portions of the first and second cylinders 10, 12 within the respective recesses 18, 20 will not contact one another, at least prior to the welding operation. The resulting gap does not generally cause any significant drawbacks in subsequent processing steps, particularly as the gap may be filled during, for example, elongating into a fiber or the like. Similar to the first recess 18, the second recess 20 may be formed before or after the second holes 16 are formed.

As before, in embodiments where more than two cylinders are used to make the preform, it may be advisable to form recesses on both ends of a cylinder. For example, an intermediate recess (not shown) may be formed in the second end 10b of the first cylinder 10, with the intermediate recess having a diameter less than an outer diameter of the first cylinder 10 such that each of the first holes 14 terminates at the intermediate recess at a location axially spaced apart from the second end 10b of the first cylinder 10. A similar intermediate recess may be made in the first end 12a of the second cylinder 12, if needed. As with the first and second recesses 18, 20, intermediate recesses may be made in any desired order relative to the hole(s) to which they apply.

Once the respective holes 14, 16 and recesses 18, 20 are formed in the first and second cylinders 10, 12, the first end 10a of the first cylinder 10 and the second end 12b of the second cylinder 12 are faced to one another, as shown, for example, in FIGS. 1 and 6. The plurality of first holes 14 may then be axially aligned with respective ones of the plurality of second holes 16. This action may be performed, for example, using a rotational alignment jig 22, such as shown in FIG. 2, although other methods of alignment, such as through one or more dummy rods, laser alignment, combinations thereof, or the like may be utilized as well. The alignment jig 22 may include a spacer plate 24 with a plurality of first prongs 26 extending in a first direction away from the spacer plate 24 and a plurality of second prongs 28 extending away from the spacer plate 24 in an opposite direction. Each first prong 26 may be axially aligned with a respective second prong 28. The orientations of each of the first and second prongs 26, 28 on the spacer plate 24 are preferably matched to the patterns of first and second holes 14, 16 in the first and second cylinders 10, 12, although the alignment jig 22 may also have fewer first and second prongs 26, 28 than there are first and second holes 14, 16 (e.g., it may be possible to align the cylinders 10, 12 using only two first prongs 26 and two second prongs 28 even if there are, for example, five holes 14, 16 in each cylinder 10, 12).

As seen in FIG. 2, the first prongs 26 may be inserted into two or more of the first holes 14 at the first end 10a of the first cylinder 10. As a result, the second prongs 28 extend away from the first end 10a of the first cylinder 10. The second cylinder 12 may then be axially aligned with the first cylinder 10 (e.g., longitudinal axes of each of the first and second cylinders 10, 12 may be aligned with each other). The second cylinder 12 may then be rotated until two or more of the second holes 16 align with the second prongs 28 of the alignment jig 22, and the second prongs 28 may then be inserted into the two or more of the second holes 16. The first and second holes 14, 16 are now axially aligned with one another, as shown in FIG. 2, with the alignment jig 22 in place. A rotational position of the first and second cylinders 10, 12 may then be fixed with respect to each other, such as by temporary clamping elements (not shown), or the like, applied to outer surfaces of the first and second cylinders 10, 12 and/or to the exposed ends 10b, 12a of the first and second cylinders 10, 12. In other embodiments, the first and second cylinders 10, 12 may be mounted in a chuck system (not shown) or the like to maintain rotational position. The alignment jig 22 may then be removed from the first and second holes 14, 16.

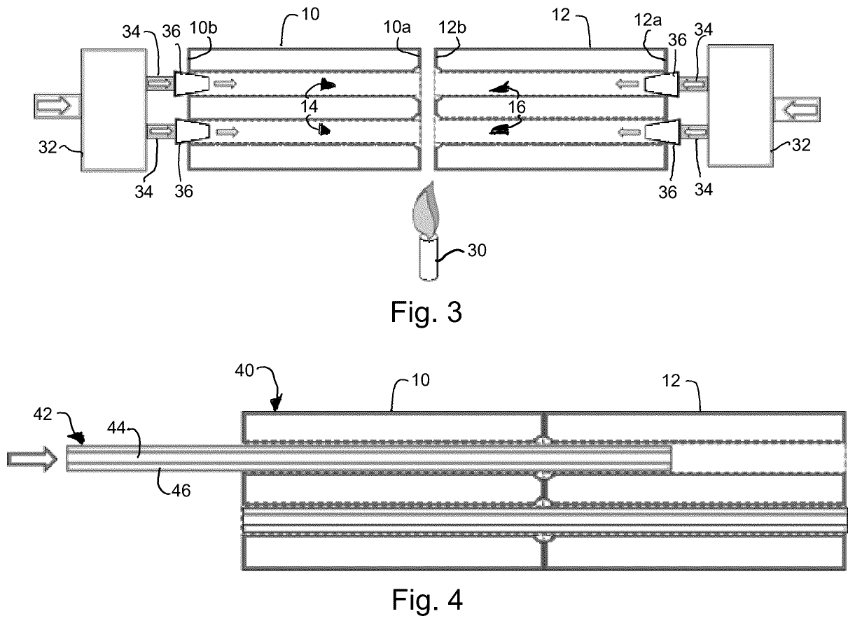

Referring to FIG. 3, the first end 10a of the first cylinder 10 and the second end 12b of the second cylinder 12 may then be welded to one another by bringing the corresponding ends 10a, 12b into contact with one another in the presence of a heat source 30, such as a propane torch, plasma torch, or the like, or any other heat source useful for locally softening the material of the first and second cylinders 10, 12 at the joint between the first end 10a of the first cylinder 10 and the second end 12b of the second cylinder 12. In some embodiments, welding may be performed over a period of about 70 minutes at a temperature between about 1500° C. and about 2000° C., although other times and temperatures may be used as well depending on the materials, sizes, and the like. The first and second cylinders 10, 12 may be rotated together during the welding procedure, such as by a chuck system or the like, to ensure even heating by the heat source 30.

As seen in FIG. 3, prior to and/or generally simultaneous with the welding procedure, gas may be flowed through the first and second holes 14, 16. This gas flow may be performed as a purging step with nitrogen and/or oxygen or the like and can serve to cool the insides of the holes 14, 16 and prevent deformation of inner walls between the holes 14, 16 during welding. When more holes 14, 16 are present in the first and second cylinders 10, 12, the walls between the holes 14, 16 are thinner. Thus, when more holes 14, 16 are present, a higher flow rate for the gas may be utilized to better prevent inner wall deformation. In one example, with a seven hole MCF, the flow rate may be about 6 PSIG, although other flow rates may be used depending on design factors and the like.

The purging assembly may include one or more manifolds 32 that may receive purging gas from one or more gas containers (not shown). The manifold(s) 32 may include tubing 34 connected to plugs 36 that may be inserted into the first and second holes 14, 16, preferably at the second end 10b of the first cylinder 10 and the first end 12a of the second cylinder, respectively. The tubing 34 may be flexible or rigid. Purging gas may be delivered from the manifold(s) 32 through the tubing 34 and the plugs 36 to the first and second holes 14, 16. Although two manifolds 32 are shown in FIG. 3, a single manifold 32 may be provided with tubing 34 that may extend to both the second end 10b of the first cylinder 10 and the first end 12a of the second cylinder 12. In still other embodiments, multiple manifolds 32 may be provided, each connected to one or more plugs 36. In still further embodiments, the manifolds 32 may be omitted altogether and the cylinders 10, 12 may be connected directly to gas containers. In still other embodiments, purging gas may be provided to only one end of the first and second cylinders 10, 12.

The facing, alignment, welding, and purging procedures may be repeated for attaching additional cylinders (not shown).

Referring now to FIG. 4, the first and second cylinders 10, 12 (along with any additional cylinders) form a cladding 40 wherein respective first and second holes 14, 16 are aligned with one another. Respective core rod assemblies 42 may now be inserted into the aligned first and second holes 14, 16. Each core rod assembly 42 may comprise a coaxial arrangement of a core rod 44 radially surrounded by a glass cladding 46. The core rod 44 is preferably a mostly high purity quartz glass with doped and un-doped regions to achieve the appropriate refractive index profile. The cladding 46 may be pure quartz glass or a doped quartz glass. Preferably, however, the cladding 46 is of the highest purity synthetic silica whether it is un-doped or doped (e.g., with Fluorine). The cladding 46 and the core rod 44 may each be formed by any suitable process, such as fused quartz or one or more types of chemical vapor deposition (CVD), including inside vapor deposition, outside vapor deposition, and vapor axial deposition. The core rod 44 typically has a refractive index which is greater than the refractive index of the material in the surrounding cladding 46 to enable internal reflection of light signals passing through a fiber elongated from the preform, resulting in an effective waveguide.

A length of each core rod assembly 42 may be generally equal to or greater than a combined length of the first and second cylinders 10, 12. In other words, each core rod assembly 42 may have a length generally equal to a length of the assembled cladding 40 (regardless of the number of cylinders welded together), although there may be instances in which a greater length is needed for handling or the like. Such core rod assemblies 42 may be shortened prior to fiber elongation, if necessary. In other embodiments, multiple core rod assemblies 42 may be inserted together within a single set of first and second holes 14, 16, each being shorter than the cladding 40 length, although the combined length of the inserted core rod assemblies 42 may equal or exceed the cladding 40 length. In still other embodiments, each core rod assembly 42 may be shorter than a length of the cladding 40, such as where welded parts or end portions of the cladding 40 may not be used for fiber elongation and so having core material in those parts would waste material.

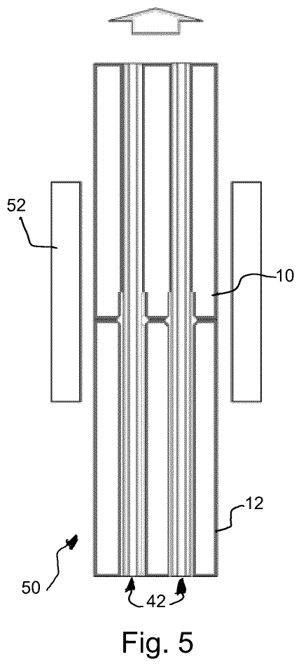

Referring to FIG. 5, a multicore fiber preform 50, having been manufactured according to embodiments described above, may be heated in a furnace 52 to collapse the first and second cylinders 10, 12 (and any other cylinders used to make the preform 50) onto the inserted core rod assemblies 42 and to elongate the multicore fiber preform 50 into a second preform or a multicore optical fiber. In the embodiments shown in FIG. 5, the furnace 52 may heat the multicore fiber preform 50 at temperatures of between about 1600° C. and about 2200° C., although other temperatures may be used as well depending on materials, sizes, and the like. However, other methods for collapsing and elongating a preform, and particularly a multicore fiber preform, may be used as well in connection with a multicore fiber preform 50 manufactured according to embodiments described above. The elongation step may be performed simultaneously with the collapsing step or may be performed subsequent to the collapsing step.

Those skilled in the art will recognize that boundaries between the above-described operations are merely illustrative. The multiple operations may be combined into a single operation, a single operation may be distributed in additional operations and operations may be executed at least partially overlapping in time. Further, alternative embodiments may include multiple instances of a particular operation, and the order of operations may be altered in various other embodiments.

While specific and distinct embodiments have been shown in the drawings, various individual elements or combinations of elements from the different embodiments may be combined with one another while in keeping with the spirit and scope of the disclosure. Thus, an individual feature described herein only with respect to one embodiment should not be construed as being incompatible with other embodiments described herein or otherwise encompassed by the disclosure.

It will be appreciated by those skilled in the art that changes could be made to the embodiments described above without departing from the broad concepts embodied therein. It is understood, therefore, that the present disclosure is not limited to the particular embodiments disclosed, but it is intended to cover modifications within the spirit and scope of the present disclosure.

1. A method of manufacturing a multicore fiber preform, the method comprising:
(a) providing a first cylinder extending longitudinally between opposing first and second ends;
(b) providing a second cylinder extending longitudinally between opposing first and second ends;
(c) forming a plurality of first holes in the first cylinder that each have a generally constant first inner diameter and extend longitudinally through the first cylinder and forming a plurality of second holes in the second cylinder that each have a generally constant second inner diameter and extend longitudinally through the second cylinder;
(d) forming at least one first recess in the first end of the first cylinder such that the plurality of first holes each terminate at the at least one first recess at a location axially spaced apart from the first end of the first cylinder;
(e) facing the first end of the first cylinder to the second end of the second cylinder and axially aligning each of the plurality of first holes with respective ones of the plurality of second holes;
(f) welding the first end of the first cylinder to the second end of the second cylinder; and
(g) for each first hole and its respective axially aligned second hole, inserting a respective core rod assembly.

2. The method of claim 1, wherein the at least one first recess comprises a plurality of first recesses, each of the plurality of first recesses being connected to a respective one of the plurality of first holes, each of the plurality of first recesses forming an opening at the first end of the first cylinder having a diameter that is greater than the first inner diameter.

3. The method of claim 2, wherein the plurality of first recesses are formed by removing material from the first cylinder surrounding the first holes at the first end of the first cylinder.

4. The method of claim 3, wherein the plurality of first recesses are formed by chamfering edges of the first holes at the first end of the first cylinder.

5. The method of claim 2, further comprising forming a plurality of second recesses in the second end of the second cylinder, each of the plurality of second recesses being connected to a respective one of the plurality of second holes such that the plurality of second holes each terminate at respective ones of the second recesses at a location axially spaced apart from the second end of the second cylinder, each of the plurality of second recesses forming an opening at the second end of the second cylinder having a diameter that is greater than the second inner diameter.

6. The method of claim 2, further comprising forming a plurality of intermediate recesses in the second end of the first cylinder, each of the plurality of intermediate recesses being connected to a respective one of the plurality of first holes such that the plurality of first holes each terminate at respective ones of the intermediate recesses at a location axially spaced apart from the second end of the first cylinder, each of the plurality of intermediate recesses forming an opening at the second end of the first cylinder having a diameter that is greater than the first inner diameter.

7. The method of claim 1, wherein the at least one first recess comprises a single first recess having a diameter less than an outer diameter of the first cylinder, each of the first holes being connected to the single first recess.

8. The method of claim 7, further comprising forming a second recess in the second end of the second cylinder, the second recess having a diameter less than an outer diameter of the second cylinder, such that the plurality of second holes each terminate at the second recess at a location axially spaced apart from the second end of the second cylinder.

9. The method of claim 7, further comprising forming an intermediate recess in the second end of the first cylinder, the intermediate recess having a diameter less than an outer diameter of the first cylinder, such that the plurality of first holes each terminate at the intermediate recess at a location axially spaced apart from the second end of the first cylinder.

10. The method of claim 1, wherein the step of axially aligning each of the plurality of first holes with respective ones of the plurality of second holes comprises:
(i) inserting first prongs of a rotational alignment jig into two or more of the plurality of first holes at the first end of the first cylinder such that second prongs extend away from the first end of the first cylinder,
(ii) axially aligning the first cylinder with the second cylinder and rotating the second cylinder until two or more of the plurality of second holes align with the second prongs of the rotational alignment jig,
(iii) inserting the second prongs into the two or more of the plurality of second holes,
(iv) fixing a rotational position of the first and second cylinders with respect to each other, and
(v) removing the alignment jig from the first holes and the second holes.

11. The method of claim 1, further comprising during welding, flowing gas through the first and second holes.

12. The method of claim 1, wherein a length of each core rod assembly is generally equal to or greater than a combined length of the first cylinder and the second cylinder.

13. A method of manufacturing a multicore optical component, the method comprising:
(a) providing a multicore fiber preform according to claim 1; and
(b) heating the multicore fiber preform in a furnace to collapse the first and second cylinders onto the inserted core rod assemblies and to elongate the multicore fiber preform into one of a second preform or a multicore optical fiber, wherein the elongation step is one of performed simultaneously with the collapsing step or following the collapsing step.
